(19) United States
(12) Patent Application Publication
(10) Pub. No.: US 2026/0028840 A1
(43) Pub. Date: Jan. 29, 2026

(54) Swimming Pool Safety System

(71) Applicant: Samantha Hughes, Woodworth, LA (US)

(72) Inventor: Samantha Hughes, Woodworth, LA (US)

(21) Appl. No.: 19/060,865

(22) Filed: Feb. 24, 2025

Related U.S. Application Data
(60) Provisional application No. 63/675,350, filed on Jul. 25, 2024.

(51) Int. Cl. E04H 4/06; G08B 21/08

(52) U.S. Cl. CPC E04H 4/06; G08B 21/086

(57) ABSTRACT

A swimming pool safety system is provided. The system is designed to prevent unattended swimming pool accidents through continuous monitoring and automated alert mechanisms. The system comprises multiple layers of protection, including infrared barrier sensors that project horizontal beams to detect perimeter breaches, water pressure sensors that identify disturbances caused by sudden water displacement, and motion detectors that monitor movement around the pool area. These sensors are configured to reduce false alarms and ensure comprehensive coverage. When a breach is detected, the system activates a dual-alert protocol, which includes a 100- to 120-decibel audible alarm emitted through weatherproof speakers and a high-intensity LED strobe light for visual alerts. The system is controlled via a waterproof digital control panel requiring a personalized security code, which allows users to activate, deactivate, and configure settings.

### CROSS-REFERENCE TO RELATED APPLICATION

The present application claims priority to, and the benefit of, U.S. Provisional Application No. 63/675,350, which was filed on Jul. 25, 2024, and is incorporated herein by reference in its entirety.

### FIELD OF THE INVENTION

The present invention relates generally to the field of swimming pools. More specifically, the present invention relates to a swimming pool safety system that uses infrared barrier sensors, water pressure sensors, and motion detectors to monitor for unauthorized or accidental pool entry, activating a dual-alert protocol with an audible alarm and high-intensity LED strobe light when a breach is detected. The system is controlled through a waterproof digital panel requiring a personalized security code, ensuring only authorized users can activate, deactivate, or configure the system's settings. Accordingly, the present disclosure makes specific reference thereto. Nonetheless, it is to be appreciated that aspects of the present invention are also equally applicable to other like applications, devices, and methods of manufacture.

### BACKGROUND

Unattended swimming pools pose a significant safety hazard, particularly for children and pets who may inadvertently enter the pool area. Drowning incidents are a leading cause of injury and death in residential environments, and these accidents often occur when pools are not actively monitored. Traditional safety measures, such as fences and covers, while helpful, are not always effective in preventing unauthorized or accidental entry into the pool. Additionally, homeowners may forget to secure these physical barriers or leave them open after use. Even in homes where adults are present, lapses in supervision can occur, leaving vulnerable individuals at risk. Pool safety remains a critical concern, necessitating a system that reliably alerts homeowners to unauthorized access. The need for an automatic, user-friendly solution that can promptly warn of potential emergencies has become more pronounced. Consequently, technological advancements in alarm systems provide a promising approach to mitigate these dangers. The objective is to ensure timely alerts, enhance pool safety, and ultimately prevent tragic incidents.

Therefore, there exists a long-felt need in the art for an improved swimming pool safety system that is activated when a pool is not in use. There also exists a long-felt need in the art for an improved swimming pool safety system that employs a reliable sensor network to detect unauthorized entry. Moreover, there exists a long-felt need in the art for an improved swimming pool safety system that emits a loud auditory alert to notify homeowners and neighbors of potential emergencies.

The subject matter disclosed and claimed herein, in one embodiment thereof, comprises a swimming pool safety system. The system is designed to prevent unattended swimming pool accidents through continuous monitoring and automated alert mechanisms. The system comprises multiple layers of protection, including infrared barrier sensors that project horizontal beams to detect perimeter breaches, water pressure sensors that identify disturbances caused by sudden water displacement, and motion detectors that monitor movement around the pool area. These sensors are configured to reduce false alarms and ensure comprehensive coverage. When a breach is detected, the system activates a dual-alert protocol, which includes a 100- to 120-decibel audible alarm emitted through weatherproof speakers and a high-intensity LED strobe light for visual alerts. The system is controlled via a waterproof digital control panel requiring a personalized security code, which allows users to activate, deactivate, and configure settings.

In this manner, the swimming pool safety system of the present invention accomplishes all the forgoing objectives and provides a pool alarm equipped with sensors that create an invisible safety barrier. The system allows users to activate and deactivate the sensors using a specific code, ensuring control and customization. When the barrier is breached without proper deactivation, the system triggers a loud auditory signal, immediately alerting nearby individuals to the potential danger. This approach ensures that even if traditional barriers fail or are left open, a reliable mechanism is in place to detect unauthorized access and prompt swift action. The invention enhances overall pool safety, reducing the risk of accidents and providing peace of mind for homeowners.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a swimming pool safety system. The swimming pool safety system is an alarm and monitoring solution designed to prevent accidents in unattended pools by employing multiple sensors and automated alerts. The system offers continuous monitoring and rapid detection of unauthorized or accidental pool entry.

The system includes a multi-layered sensor network to ensure redundancy and reliable detection. An infrared barrier sensor projects horizontal beams around the pool's perimeter, typically at or just above the water's surface. If the beam is interrupted by a person, pet, or object, an alarm is triggered before full entry into the pool occurs.

A water pressure sensor is submerged within the pool to detect changes in water pressure caused by splashes or displacement. This sensor provides protection when the infrared sensor does not activate, such as during gradual entry. The placement and sensitivity of the water pressure sensor are optimized for detecting varying weights and sizes of potential entrants.

A motion detector monitors movement within a defined radius around the pool. These detectors can be angle-adjusted and are designed to distinguish between significant motion, such as that of people or pets, and minor disturbances to minimize false alarms.

When a sensor breach is detected, the system activates a dual-alert alarm protocol. An audible alarm emits sound through at least one speaker, with a volume ranging from 100 to 120 decibels. The speaker, housed in a weatherproof enclosure, can produce different alarm tones based on user preference. Additionally, a high-intensity LED strobe light provides a visual alert, enhancing safety for hearing-impaired individuals and improving visibility in low-light conditions. The brightness of the strobe light is adjustable, and it may be powered by a rechargeable battery connected to a solar panel.

The system is controlled via a wall-mounted, waterproof digital control panel. The control panel features backlit keys for visibility in low-light conditions, a display for real-time system status, and security measures such as a personalized security code.

The method of using the swimming pool safety system includes the following steps. First, the system is provided, comprising at least one infrared barrier sensor, at least one water pressure sensor, at least one motion detector, an audible alarm, a strobe light alert, and a waterproof digital control panel. The system is then activated via the control panel by entering a personalized security code. Once activated, the sensors continuously monitor for any unauthorized or accidental entry into the pool. If the infrared barrier sensor detects a breach, or the water pressure sensor or motion detector identifies an entry event, the system activates the dual-alert alarm protocol. The audible alarm emits a sound ranging from 100 to 120 decibels through the speaker, while the high-intensity LED strobe light provides a visual alert. The system can be deactivated via the control panel using the personalized security code or through a wireless key fob, ensuring only authorized individuals can control the system.

Accordingly, the swimming pool safety system of the present invention is particularly advantageous as it provides a pool alarm equipped with sensors that create an invisible safety barrier. The system allows users to activate and deactivate the sensors using a specific code, ensuring control and customization. When the barrier is breached without proper deactivation, the system triggers a loud auditory signal, immediately alerting nearby individuals to the potential danger. This approach ensures that even if traditional barriers fail or are left open, a reliable mechanism is in place to detect unauthorized access and prompt swift action. The invention enhances overall pool safety, reducing the risk of accidents and providing peace of mind for homeowners. In this manner, the swimming pool safety system overcomes the limitations of existing swimming pools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a swimming pool safety system of the present invention positioned around a pool in accordance with the disclosed architecture; and

FIG. 2 illustrates a flowchart of a method of using one potential embodiment of a swimming pool safety system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved swimming pool safety system that is activated when a pool is not in use. There also exists a long-felt need in the art for an improved swimming pool safety system that employs a reliable sensor network to detect unauthorized entry. Moreover, there exists a long-felt need in the art for an improved swimming pool safety system that emits a loud auditory alert to notify homeowners and neighbors of potential emergencies.

The present invention, in one exemplary embodiment, is comprised of a swimming pool safety system. The swimming pool safety system is an alarm and monitoring solution designed to prevent accidents in unattended pools by utilizing multiple sensors and automated alerts. This system provides continuous monitoring and rapid detection of unauthorized or accidental entry into the pool.

The system features a multi-layered sensor network that ensures redundancy and reliable detection. An infrared barrier sensor projects horizontal beams around the pool's perimeter, typically positioned at or just above the water's surface. When a person, pet, or object interrupts the beam, the system triggers an alarm before full entry into the pool.

A water pressure sensor is submerged within the pool to detect changes in water pressure caused by splashes or displacement. This sensor provides protection when the infrared sensor does not activate, such as during gradual entry. The placement and sensitivity of the water pressure sensor are configured to detect different weights and sizes of potential entrants.

A motion detector monitors movement within a defined radius around the pool. These detectors can be adjusted for angle and are designed to differentiate significant motion, such as that caused by people or pets, from minor disturbances, minimizing false alarms.

When a sensor breach occurs, the system activates a dual-alert alarm protocol. An audible alarm emits sound through at least one speaker, with a volume ranging between 100 and 120 decibels. The speaker, housed in a weatherproof enclosure, can produce various alarm tones based on user preference. Additionally, a high-intensity LED strobe light provides a visual alert, improving safety for hearing-impaired individuals and enhancing visibility in low-light conditions. The brightness of the strobe light is adjustable, and it can be powered by a rechargeable battery connected to a solar panel.

The system is managed through a wall-mounted, waterproof digital control panel. The control panel includes backlit keys for improved visibility in low-light conditions, a display for real-time status updates, and a personalized security code for enhanced security.

The method for using the swimming pool safety system involves the following steps. First, the system is provided, comprising at least one infrared barrier sensor, one water pressure sensor, one motion detector, an audible alarm, a strobe light alert, and a waterproof digital control panel. The system is activated via the control panel by entering a personalized security code. Once armed, the sensors continuously monitor for unauthorized or accidental entry. If a breach is detected by the infrared barrier sensor, water pressure sensor, or motion detector, the system activates the dual-alert alarm protocol. The audible alarm emits a sound between 100 and 120 decibels through the speaker, while the strobe light provides a visual alert. The system can be deactivated via the control panel using the security code or through a wireless key fob, ensuring only authorized individuals control the system.

This swimming pool safety system offers significant advantages by providing a pool alarm with sensors that create an invisible safety barrier. The system allows users to activate and deactivate sensors using a personalized code for controlled access. If the barrier is breached without proper deactivation, the system triggers a loud alarm, immediately notifying individuals of potential danger. This ensures that even if physical barriers fail or are left open, a reliable detection mechanism remains in place. The invention enhances pool safety, reduces the risk of accidents, and offers homeowners peace of mind by overcoming the limitations of existing pools.

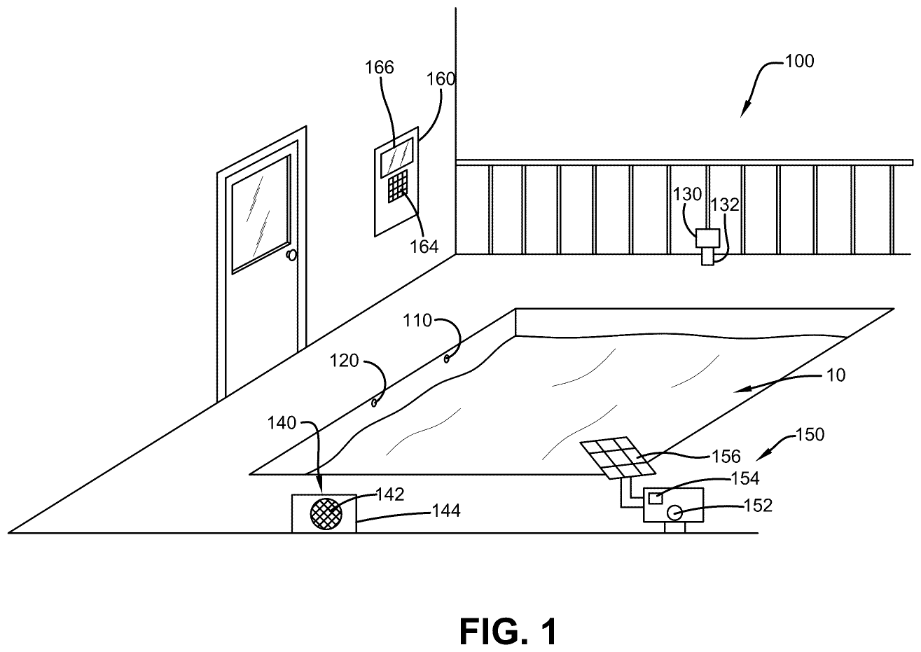

Referring initially to the drawings, FIG. 1 illustrates a perspective view of one potential embodiment of a swimming pool safety system 100 of the present invention positioned around a pool 10 in accordance with the disclosed architecture. The swimming pool safety system 100 is a multi-functional alarm and monitoring solution designed to prevent accidents in an unattended pool. This system addresses a critical safety need by leveraging a combination of sensors and automated alert mechanisms. By creating multiple layers of protection, the system 100 ensures constant monitoring and rapid detection of unauthorized or accidental entry into a pool.

The swimming pool safety system 100 features a multi-layered sensor network that provides redundancy and enhanced detection capabilities. This configuration ensures that no single point of failure compromises the safety functions of the system 100. More specifically, the system 100 is comprised of at least one infrared barrier sensor 110 that projects invisible horizontal beams around the entire perimeter of pool 10, typically positioned at the surface level of pool 10 or just above it. When the beam is interrupted by a person, pet, or object entering the area of pool 10, the system 100 immediately recognizes the breach and activates a number of alarms, as will be explained more fully below. The infrared barrier sensors 110 are designed to provide early warning detection, ensuring that an alert is generated before full entry into the water of pool 10 occurs.

At least one water pressure sensor 120 is preferably positioned submerged within pool 10 and is designed to detect disturbances or changes in water pressure. When a person or object falls into pool 10, the resulting splash or water displacement triggers the sensor 120. This layer of protection is particularly effective in situations where the infrared sensor 110 does not activate, such as when an individual enters pool 10 gradually or cautiously. The pressure sensitivity of these sensors 120 are calibrated to detect varying displacement volumes, taking into account the different weights and sizes of children, pets, or objects. The system 100 can be configured to optimize the placement of the water pressure sensors 120, ensuring comprehensive coverage of pool 10's surface area.

At least one motion detector 130 is strategically installed to monitor movement within a predefined radius, such as but not limited to five to ten feet around the perimeter of pool 10, as seen in FIG. 1. These detectors 130 provide preemptive warnings by identifying individuals who are approaching pool 10, thereby reducing the risk of unnoticed entry. The motion detectors 130 may be equipped with angle-adjustable mounts 132 to optimize the coverage based on the specific layout and dimensions of pool 10. The detectors 130 are designed to differentiate between significant motion, such as that caused by a person or pet, and minor disturbances like swaying branches, minimizing false alerts.

Upon detecting a sensor breach, the system 100 activates a dual-alert alarm protocol to promptly inform homeowners and neighbors of potential danger. An audible alarm component 140 emits a sound through at least one speaker 142, with the sound ranging from 100 to 120 decibels. This volume level ensures immediate attention, even if pool 10 is situated at a distance from the main residence or if there is significant background noise. The sound produced by the speaker 142 can be any type of alert, such as a siren, continuous beep, or another recognizable alarm tone, ensuring adaptability to user preference and environmental conditions. The speaker 142 is housed in a weatherproof enclosure 144 to maintain functionality in varying outdoor conditions.

In addition to the audible alarm, the system 100 may include at least one strobe light alert assembly 150, as seen in FIG. 1. More specifically, at least one high-intensity LED strobe light 152 is mounted around the perimeter of pool 10 and activates during an alarm event. These lights 152 provide a visual alert, enhancing safety for individuals who are hearing-impaired and improving visibility during nighttime conditions or low-light environments. The strobe lights 152 feature adjustable and configurable brightness settings to accommodate different lighting conditions, ensuring the visual alert remains effective regardless of the time of day. The lights 152 are powered by at least one battery 154, which may be replaceable or rechargeable. In one embodiment, the battery 154 is recharged by a solar panel 156 connected to the light 152 via a wired connection.

A wall-mounted, waterproof digital control panel 160 allows users to activate or deactivate the system 100 using a personalized security code, as well as configure all operational parameters of all components of the system 100. This measure ensures that only authorized individuals can manage the system, enhancing security. The control panel 160 features backlit keys 164 for improved nighttime visibility, making operation straightforward in low-light conditions. Additionally, the control panel 160 includes a display 166 that provides real-time system status updates during operation, such as whether the system is armed, disarmed, or in alert mode.

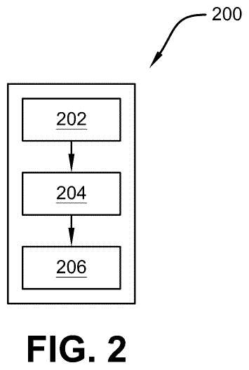

The present invention is also comprised of a method of using 200 the swimming pool safety system 100, as seen in FIG. 2. First, a swimming pool safety system 100 is provided, comprised of at least one infrared barrier sensor 110, at least one water pressure sensor 120, at least one motion detector 130, an audible alarm 140, a strobe light alert 150, and a waterproof digital control panel 160 [Step 202]. Then, the system 100 is activated using the waterproof digital control panel 160 by entering a personalized security code [Step 204]. Once the system 100 is armed, the sensors continuously monitor for any unauthorized or accidental entry into pool 10. If the infrared barrier sensor 110 detects a breach, or the water pressure sensor 120 or motion detector 130 identifies an entry event, the system 100 activates the dual-alert alarm protocol. The audible alarm 140 emits a sound ranging from 100 to 120 decibels through at least one speaker 142, while the high-intensity LED strobe light 152 provides a visual alert. Finally, the system 100 can be deactivated via the control panel 160 using the personalized security code or through a wireless key fob, ensuring only authorized individuals can control the system 100 [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “swimming pool safety system” and “system” are interchangeable and refer to the swimming pool safety system 100 of the present invention.

Notwithstanding the forgoing, the swimming pool safety system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the swimming pool safety system 100 as shown in the FIGS. are for illustrative purposes only, and that many other sizes and shapes of the swimming pool safety system 100 are well within the scope of the present disclosure. Although the dimensions of the swimming pool safety system 100 are important design parameters for user convenience, the swimming pool safety system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A swimming pool safety system comprising:
an infrared barrier sensor configured to project an invisible horizontal beam around a perimeter of a swimming pool and to detect a breach of the beam;
a water pressure sensor configured to detect a change in a water pressure within the swimming pool;
a motion detector configured to monitor a movement within a predefined radius around the perimeter of the swimming pool;
an audible alarm further comprising a speaker configured to emit a sound upon detecting a sensor breach;
a light alert configured to activate upon detecting a sensor breach; and
a digital control panel configured to activate and deactivate the swimming pool safety system using a personalized security code.

2. The swimming pool safety system of claim 1, wherein the infrared barrier sensor is positioned at a surface level of the swimming pool.

3. The swimming pool safety system of claim 1, wherein the infrared barrier sensor is positioned below a surface level of the swimming pool.

4. The swimming pool safety system of claim 1, wherein the water pressure sensor is calibrated to detect a displacement of volume within the swimming pool.

5. The swimming pool safety system of claim 1, wherein the motion sensor is further comprised of an angle adjustable mount.

6. The swimming pool safety system of claim 1, wherein the speaker is configured to emit a sound ranging from 100 to 120 decibels.

7. The swimming pool safety system of claim 1, wherein the light alert is powered by a battery.

8. The swimming pool safety system of claim 1, wherein the digital control panel is further comprised of a backlit key.

9. The swimming pool safety system of claim 1, wherein the digital control panel is further comprised of a display.

10. The swimming pool safety system of claim 9, wherein the display provides a status update on the swimming pool safety system.

11. The swimming pool safety system of claim 1, wherein the digital control panel is configured to allow configuration of operational parameters of the infrared barrier sensor, the water pressure sensor, and the motion detector.

12. A swimming pool safety system comprising:
an infrared barrier sensor configured to project an invisible horizontal beam around a perimeter of a swimming pool and to detect a breach of the beam;
a water pressure sensor configured to detect a change in a water pressure within the swimming pool;
a motion detector configured to monitor a movement within a predefined radius around the perimeter of the swimming pool;
an audible alarm further comprising a speaker configured to emit a sound upon detecting a sensor breach;
a strobe light alert configured to activate upon detecting a sensor breach; and
a waterproof digital control panel configured to activate and deactivate the swimming pool safety system using a personalized security code.

13. The swimming pool safety system of claim 12, wherein the speaker is further comprised of a waterproof enclosure.

14. The swimming pool safety system of claim 12, wherein the strobe light alert is further comprised of an adjustable brightness setting.

15. The swimming pool safety system of claim 12, wherein the strobe light alert is further comprised of and is powered by a solar-rechargeable battery.

16. The swimming pool safety system of claim 12, wherein the digital control panel is further comprised of a backlit key.

17. The swimming pool safety system of claim 12, wherein the digital control panel is further comprised of a display.

18. The swimming pool safety system of claim 17, wherein the display provides a status update on the swimming pool safety system.

19. The swimming pool safety system of claim 12, wherein the motion sensor is further comprised of an angle adjustable mount.

20. A method of using a swimming pool safety system, the method comprising the following steps:
providing a swimming pool safety system comprised of an infrared barrier sensor, a water pressure sensor, a motion detector, an audible alarm further comprising a speaker, and a strobe light alert;
activating the swimming pool safety system via a waterproof digital control panel using a personalized security code; and
monitoring for a breach of a swimming pool the swimming pool safety system is monitoring using the infrared barrier sensor, the water pressure sensor, and the motion detector.
